(19) United States
(12) Patent Application Publication
(10) Pub. No.: US 2025/0095511 A1
(43) Pub. Date: Mar. 20, 2025

(54) ARTIFICIAL THREE-DIMENSIONAL (3D) CRYSTALS AND USE OF THE SAME AS AN EDUCATIONAL TOOL

(71) Applicant: Arizona Board of Regents on Behalf of the University of Arizona, Tucson, AZ (US)

(72) Inventors: Ryane Englar, Oro Valley, AZ (US); Eric Beasley, Oro Valley, AZ (US)

(21) Appl. No.: 18/889,011

(22) Filed: Sep. 18, 2024

Related U.S. Application Data
(60) Provisional application No. 63/538,898, filed on Sep. 18, 2023.

(51) Int. Cl. G09B 23/26

(52) U.S. Cl. CPC G09B 23/26

(57) ABSTRACT

Provided herein are educational models that include a substrate and one or more 3D printed structures mounted or affixed thereon, where the one or more 3D printed structures resemble crystals, normal and/or abnormal cells, or casts found in a biofluid. Also provided herein are educational models that include one or more 3D printed structures contained (for example, dispersed or suspended) in a carrier, where the one or more 3D printed structures resemble crystals, normal and/or abnormal cells, or casts found in a biofluid. Also provided herein are kits having a plurality of educational models, where each of the educational model is individually identifiable, and an answer key or guide that provides an identification of each 3D printed structure contained in each of the plurality of individually identifiable educational models. The 3D printed structures can be dimensioned for viewing with the naked eye or can be dimensioned for viewing under magnification.

### CROSS REFERENCE TO RELATED APPLICATION

This application claims the benefit of U.S. Provisional Application No. 63/538,898 filed Sep. 18, 2024, the entire contents of which are incorporated by reference herein.

### FIELD OF THE INVENTION

The present disclosure generally relates to 3D printed structures resembling crystals, cells, casts, or other target bio-analytes normally found in biofluids. Such 3D printed structures serve as a valuable educational tool for training medical and veterinary students to detect and identify said crystals, cells, casts, or other target bio-analytes and differentiate between normal and abnormal cells using light microscopy during routine baseline clinical diagnostic tests.

### BACKGROUND

Clinical reasoning drives health care delivery and affects patient outcomes by influencing diagnostic and treatment planning. In order to make informed decisions that reflect contextualized care, providers must gather patient-specific data from a variety of sources. History taking and physical examination disclose patient-specific findings that contribute to diagnostic accuracy by guiding next steps. The minimum database is said to include those tests that are required to consistently achieve an accurate diagnosis. With respect to clinical pathology, the minimum database has historically included urinalysis (UA) to establish baseline data and identify trends.

Crystalluria is frequently identified on urine sediment examination. It may be an incidental finding in clinically healthy dogs and cats or may highlight underlying pathology, such as urinary tract infections (UTIs) that originate from urease-producing bacteria. Crystalluria may also be a precursor to urolithiasis. In human health care, crystalluria carries predictive value: urolith reoccurrence in people is likely if crystals of the same type as the original urolith are excreted in the urine. In veterinary medicine, cats with lower urinary tract disease often pass struvite (also known as magnesium ammonium phosphate and triple phosphate) crystals, and struvites currently make up the bulk of mineral in feline urethral plugs that potentiate urinary tract obstruction (UTO). Struvite has also been identified as a key component of canine uroliths since the 1980s.

The other primary mineral in urolithiasis is calcium oxalate. The rise in calcium oxalate uroliths has been attributed to interventional dietary and medical strategies designed to dissolve struvite uroliths through urine acidification. Together, struvite and calcium oxalate are the predominant minerals in urolithiasis, accounting for greater than 80% of clinical cases. For this reason, health care providers and their teams must be able to identify crystalluria on urine sediment examination and differentiate between crystal types to implement appropriate interventional strategies. Providers also must be able to apply their foundational knowledge to case management because the detection of crystalluria from patients with confirmed urolithiasis may be diagnostically or therapeutically important.

Diagnostic accuracy of UA is achieved by analyzing freshly collected samples of urine. Delayed analysis following routine collection impedes urine sediment examination because of bacterial growth and degeneration of cellular elements including lysis of erythrocytes in dilute urine. In addition, crystals may degenerate beyond recognition or dissolve altogether. This presents a challenge to human and veterinary medical educators who may desire to incorporate UA into scheduled laboratories in the pre-clinical curriculum that will be held regardless of caseload and clinical presentations.

Medical and veterinary students at academic institutions are expected to be able to perform UA in Clinical Skills laboratories and Teaching Hospitals following exposure to core coursework that details urinary tract anatomy, physiology, and pathology. At veterinary institutions, students, staff, and faculty can voluntarily contribute free-catch, voided samples from owned animals (e.g., dogs) to the laboratory for practice performing diagnostic UA, but there is often significant lag time between collection of the samples and classroom analysis. University-owned equine and bovine teaching herds augment the urine supply in compliance with Institutional Animal Care and Use Committee (IACUC) guidelines, but at many academic institutions there are no on-site teaching hospitals to provide samples from symptomatic patients whose urine sediments are more likely to be active. In theory, in-state, clinical affiliates of academic institutions that participate in distributive teaching models could hold leftover urine that is slated for biohazard disposal following their own analysis; however, time delays and sample deterioration are likely. Consent from pet owners is also required to permissibly make use of patient samples for teaching purposes.

Textbook images and peer-reviewed, published case reports offer substitutes for experiential learning in the absence of diagnostic patient samples. However, these read-only modalities lack hands-on experiences with sample preparation and interpretation. Permanent mounts offer a hands-on alternative to passive learning and were traditionally accomplished with balsam or synthetic resins; however, the process has historically been time-consuming and required highly toxic solvents. Other methods of preservation have since been developed that expedite prep time, including Gum Arabic mountants and air-drying techniques, followed by rehydration and fixation. The resultant slides will last for decades, yet toxicity remains a concern because some procedures still require toxic agents, such as formaldehyde or flammable H226. These preparation techniques also require that the educator have access to samples to preserve or that samples are commercially available for purchase, neither of which are guaranteed. There is no guarantee, for instance, that an educator will have access to a urine sample from a cat that ingested ethylene glycol and has developed resultant crystalluria of the calcium oxalate variety. Without said sample, the educator cannot preserve this crystal type for future use in training diagnostic interpretation.

The emphasis on developing tactile task trainers for procedural medicine has limited exploration of manufacturing novel biofluids that recreate common clinical abnormalities. To date, validated studies involving the use of simulated urine for clinical skills training have not appeared in the veterinary medical literature. Simulated “urine” that can replicate changes in urine pH or urine-specific gravity (USG) is commercially available. Simulated “urine” can also replicate proteinuria, glucosuria, and ketonuria.

Human urine has also been adapted for commercial use through a manufacturing process that preserves erythrocytes, leukocytes, and rod-shaped bacteria. This product is said to be compatible with most urine dipsticks, manual microscopy methods, and automated analyzers, and is sold as a UA dipstick and sediment combination quality control for the clinical laboratory. An additional feature is the inclusion of reportedly engineered calcium oxalate dihydrate crystals. Experimentation with this product in Clinical Skills coursework has shown, however, that its distribution of cellular constituents is unpredictable to the point that an objective structured clinical examination (OSCE) may require reconfiguring due to inability to find sufficient crystalluria for identification.

### SUMMARY OF THE DISCLOSURE

Various aspects of the present disclosure are directed to the fabrication and use of to 3D printed structures resembling crystals, cells, casts, or other target bio-analytes normally found in biofluids, as an educational tool for training medical and veterinary students to visually detect and identify said crystals, cells, casts, or other target bio-analytes and differentiate between normal and abnormal cells.

In accordance with various aspects of the disclosure, a first aspect of the disclosure can be described as an educational model comprising a substrate, and one or more 3D printed structures mounted or affixed on the substrate, the one or more 3D printed structures resembling crystals found in a biofluid.

In some instances, a second aspect of the disclosure can be described as an educational model according to the first aspect, wherein the one or more 3D printed structures resemble one or more of struvite crystals, calcium oxalate monohydrate crystals and calcium oxalate dihydrate crystals.

In some instances, a third aspect of the disclosure can be described as an educational model according to the first or second aspects, wherein the one or more 3D printed structures resemble one or more of bilirubin crystals, calcium carbonate crystals, ammonium biurate crystals, cystine crystals, drug-associated crystals, amorphous crystals, melamine crystals, allantoin crystals, leucine crystals, tyrosine crystals, and uric acid crystals.

In some instances, a fourth aspect of the disclosure can be described as an educational model according to any one of the first through third aspects, wherein the substrate is a glass slide or a polycarbonate slide.

In accordance with various aspects of the disclosure, a fifth aspect of the disclosure can be described as an educational model comprising a substrate, and one or more 3D printed structures mounted or affixed on the substrate, the one or more 3D printed structures resembling normal and/or abnormal cells found in a biofluid.

In some instances, a sixth aspect of the disclosure can be described as an educational model according to the fifth aspect, wherein the one or more 3D printed structures resemble normal and abnormal spermatozoa.

In some instances, a seventh aspect of the disclosure can be described as an educational model according to the sixth aspect, wherein the one or more 3D printed structures resembling abnormal spermatozoa resemble abnormal spermatozoa exhibiting double tails, bent, coiled or stump tails, multiple or misshapen heads.

In some instances, an eighth aspect of the disclosure can be described as an educational model according to the fifth aspect, wherein the one or more 3D printed structures resemble normal and abnormal red blood cells (erythrocytes).

In some instances, a ninth aspect of the disclosure can be described as an educational model according to the fifth aspect, wherein the one or more 3D printed structures resemble normal and abnormal white blood cells (leukocytes).

In some instances, a tenth aspect of the disclosure can be described as an educational model according to the fifth aspect, wherein the one or more 3D printed structures resemble normal and abnormal epithelial cells.

In some instances, an eleventh aspect of the disclosure can be described as an educational model according to the tenth aspect, wherein the substrate is a simulated skin or a simulated mucous membrane.

In some instances, a twelfth aspect of the disclosure can be described as an educational model according to any one of the fifth through tenth aspects, wherein the substrate is a glass slide or a polycarbonate slide.

In accordance with various aspects of the disclosure, a thirteenth aspect of the disclosure can be described as educational model comprising a substrate and one or more 3D printed structures mounted or affixed on the substrate, the one or more 3D printed structures resembling casts found in a biofluid.

In some instances, a fourteenth aspect of the disclosure can be described as an educational model according to the thirteenth aspect, wherein the one or more 3D printed structures resemble one or more of hyaline casts, cellular casts, granular casts, “fatty” casts, waxy casts, and red blood cell casts.

In some instances, a fifteenth aspect of the disclosure can be described as an educational model according to the thirteenth or fourteenth aspect, wherein the substrate is a glass slide or a polycarbonate slide.

In some instances, a sixteenth aspect of the disclosure can be described as an educational model according to any one of the first through fifteenth aspects, wherein the 3D printed structures exhibit micron—or smaller scale dimensions.

In accordance with various aspects of the disclosure, a seventeenth aspect of the disclosure can be described as an educational kit comprising a plurality of individually numbered educational models according to any one of the first through fifteenth aspects and an instructor answer key or guide, the instructor answer key or guide providing an instructor with an identification of each 3D printed structure contained in each of the plurality of individually numbered educational models.

In accordance with various aspects of the disclosure, an eighteenth aspect of the disclosure can be described as an educational model comprising a simulated biofluid housed in a container and one or more 3D printed structures contained within the simulated biofluid, the one or more 3D printed structures resembling crystals found in a biofluid.

In some instances, a nineteenth aspect of the disclosure can be described as an educational model according to the eighteenth aspect, wherein the one or more 3D printed structures resemble one or more of struvite crystals, calcium oxalate monohydrate crystals and calcium oxalate dihydrate crystals.

In some instances, a twentieth aspect of the disclosure can be described as an educational model according to the eighteenth or nineteenth aspects, wherein the one or more 3D printed structures resemble one or more of bilirubin crystals, calcium carbonate crystals, ammonium biurate crystals, cystine crystals, drug-associated crystals, amorphous crystals, melamine crystals, allantoin crystals, leucine crystals, tyrosine crystals, and uric acid crystals.

In some instances, a twenty-first aspect of the disclosure can be described as an educational model according to any one of the eighteenth through twentieth aspects, wherein the simulated biofluid is a simulated urine.

In some instances, a twenty-second aspect of the disclosure can be described as an educational model according to any one of the eighteenth through twenty-first aspects, wherein the container is a test tube.

In accordance with various aspects of the disclosure, a twenty-third aspect of the disclosure can be described as an educational model comprising a simulated biofluid housed in a container and one or more 3D printed structures contained within the simulated biofluid, the one or more 3D printed structures resembling normal and/or abnormal cells found in a biofluid.

In some instances, a twenty-fourth aspect of the disclosure can be described as an educational model according to the twenty-third aspect, wherein the one or more 3D printed structures resemble normal and abnormal spermatozoa.

In some instances, a twenty-fifth aspect of the disclosure can be described as an educational model according to the twenty-fourth aspect, wherein the one or more 3D printed structures resembling abnormal spermatozoa resemble abnormal spermatozoa exhibiting double tails, bent, coiled or stump tails, multiple or misshapen heads.

In some instances, a twenty-sixth aspect of the disclosure can be described as an educational model according to any one of the twenty-third through twenty-fifth aspects, wherein the simulated biofluid is an artificial seminal fluid.

In some instances, a twenty-seventh aspect of the disclosure can be described as an educational model according to the twenty-third aspect, wherein the one or more 3D printed structures resemble normal and abnormal red blood cells (erythrocytes).

In some instances, a twenty-eighth aspect of the disclosure can be described as an educational model according to the twenty-third aspect, wherein the one or more 3D printed structures resemble normal and abnormal white blood cells (leukocytes).

In some instances, a twenty-ninth aspect of the disclosure can be described as an educational model according to the twenty-seventh of twenty-eighth aspect, wherein the simulated biofluid is a simulated blood.

In some instances, a thirtieth aspect of the disclosure can be described as an educational model according to the twenty-third aspect, wherein the one or more 3D printed structures resemble normal and abnormal epithelial cells.

In some instances, a thirty-first aspect of the disclosure can be described as an educational model according to any one of the twenty-third through thirtieth aspects, wherein the container is a test tube.

In accordance with various aspects of the disclosure, a thirty-second aspect of the disclosure can be described as an educational model comprising a simulated biofluid housed in a container and one or more 3D printed structures contained within the simulated biofluid, the one or more 3D printed structures resembling casts found in a biofluid.

In some instances, a thirty-third aspect of the disclosure can be described as an educational model according to the thirty-second aspect, wherein the one or more 3D printed structures resemble one or more of hyaline casts, cellular casts, granular casts, “fatty” casts, waxy casts, and red blood cell casts.

In some instances, a thirty-fourth aspect of the disclosure can be described as an educational model according to the thirty-second aspect, wherein the simulated biofluid in a simulated urine.

In some instances, a thirty-fifth aspect of the disclosure can be described as an educational model according to any one of the thirty-second through thirty-fourth aspects, wherein the container is a test tube.

In accordance with various aspects of the disclosure, a thirty-sixth aspect of the disclosure can be described as an educational kit comprising a plurality of individually numbered educational models according to any one of the eighteenth through thirty-fifth aspects and an instructor answer key or guide, the instructor answer key or guide providing an instructor with an identification of each 3D printed structure contained in each of the plurality of individually numbered educational models.

In accordance with various aspects of the disclosure, a thirty-seventh aspect of the disclosure can be described as an educational model comprising a gel housed in a container and one or more 3D printed structures suspended in the gel, the one or more 3D printed structures resembling crystals found in a biofluid.

In some instances, a thirty-eighth aspect of the disclosure can be described as an educational model according to the thirty-seventh aspect, wherein the one or more 3D printed structures resemble one or more of struvite crystals, calcium oxalate monohydrate crystals and calcium oxalate dihydrate crystals.

In some instances, a thirty-ninth aspect of the disclosure can be described as an educational model according to the thirty-seventh or thirty-eighth aspects, wherein the one or more 3D printed structures resemble one or more of bilirubin crystals, calcium carbonate crystals, ammonium biurate crystals, cystine crystals, drug-associated crystals, amorphous crystals, melamine crystals, allantoin crystals, leucine crystals, tyrosine crystals, and uric acid crystals.

In accordance with various aspects of the disclosure, a fortieth aspect of the disclosure can be described as an educational model comprising a gel housed in a container and one or more 3D printed structures suspended in the gel, the one or more 3D printed structures resembling normal and/or abnormal cells found in a biofluid.

In some instances, a forty-first aspect of the disclosure can be described as an educational model according to the fortieth aspect, wherein the one or more 3D printed structures resemble normal and abnormal spermatozoa.

In some instances, a forty-second aspect of the disclosure can be described as an educational model according to the forty-first aspect, wherein the one or more 3D printed structures resembling abnormal spermatozoa resemble abnormal spermatozoa exhibiting double tails, bent, coiled or stump tails, multiple or misshapen heads.

In some instances, a forty-third aspect of the disclosure can be described as an educational model according to the fortieth aspect, wherein the one or more 3D printed structures resemble normal and abnormal red blood cells (erythrocytes).

In some instances, a forty-fourth aspect of the disclosure can be described as an educational model according to the fortieth aspect, wherein the one or more 3D printed structures resemble normal and abnormal white blood cells (leukocytes).

In some instances, a forty-fifth aspect of the disclosure can be described as an educational model according to the fortieth aspect, wherein the one or more 3D printed structures resemble normal and abnormal epithelial cells.

In accordance with various aspects of the disclosure, a forty-sixth aspect of the disclosure can be described as an educational model comprising a gel housed in a container and one or more 3D printed structures suspended in the gel, the one or more 3D printed structures resembling casts found in a biofluid.

In some instances, a forty-seventh aspect of the disclosure can be described as an educational model according to the forty-sixth aspect, wherein the one or more 3D printed structures resemble one or more of hyaline casts, cellular casts, granular casts, “fatty” casts, waxy casts, and red blood cell casts.

In some instances, a forty-eighth aspect of the disclosure can be described as an educational model according to any one of the thirty-seventh through forty-seventh aspects, wherein the container is a Petri dish.

In accordance with various aspects of the disclosure, a forty-ninth aspect of the disclosure can be described as an educational kit comprising a plurality of individually numbered educational models according to any one of the thirty-seventh through forty-ninth aspects and an instructor answer key or guide, the instructor answer key or guide providing an instructor with an identification of each 3D printed structure contained in each of the plurality of individually numbered educational models.

In accordance with various aspects of the disclosure, a fiftieth aspect of the disclosure can be described as an educational model comprising a resin body and one or more 3D printed structures suspended in the resin body, the one or more 3D printed structures resembling crystals found in a biofluid.

In some instances, a fifty-first aspect of the disclosure can be described as an educational model according to the fiftieth aspect, wherein the one or more 3D printed structures resemble one or more of struvite crystals, calcium oxalate monohydrate crystals and calcium oxalate dihydrate crystals.

In some instances, a fifty-second aspect of the disclosure can be described as an educational model according to the fiftieth or fifty-first aspects, wherein the one or more 3D printed structures resemble one or more of bilirubin crystals, calcium carbonate crystals, ammonium biurate crystals, cystine crystals, drug-associated crystals, amorphous crystals, melamine crystals, allantoin crystals, leucine crystals, tyrosine crystals, and uric acid crystals.

In accordance with various aspects of the disclosure, a fifty-third aspect of the disclosure can be described as an educational model comprising a resin body and one or more 3D printed structures suspended in the resin body, the one or more 3D printed structures resembling normal and/or abnormal cells found in a biofluid.

In some instances, a fifty-fourth aspect of the disclosure can be described as an educational model according to the fifty-third aspect, wherein the one or more 3D printed structures resemble normal and abnormal spermatozoa.

In some instances, a fifty-fifth aspect of the disclosure can be described as an educational model according to the fifty-fourth aspect, wherein the one or more 3D printed structures resembling abnormal spermatozoa resemble abnormal spermatozoa exhibiting double tails, bent, coiled or stump tails, multiple or misshapen heads.

In some instances, a fifty-sixth aspect of the disclosure can be described as an educational model according to the fifty-third aspect, wherein the one or more 3D printed structures resemble normal and abnormal red blood cells (erythrocytes).

In some instances, a fifty-seventh aspect of the disclosure can be described as an educational model according to the fifty-third aspect, wherein the one or more 3D printed structures resemble normal and abnormal white blood cells (leukocytes).

In some instances, a fifty-eighth aspect of the disclosure can be described as an educational model according to the fifty-third aspect, wherein the one or more 3D printed structures resemble normal and abnormal epithelial cells.

In accordance with various aspects of the disclosure, a fifty-ninth aspect of the disclosure can be described as an educational model comprising a resin body and one or more 3D printed structures suspended in the resin body, the one or more 3D printed structures resembling casts found in a biofluid.

In some instances, a sixtieth aspect of the disclosure can be described as an educational model according to the fifty-ninth aspect, wherein the one or more 3D printed structures resemble one or more of hyaline casts, cellular casts, granular casts, “fatty” casts, waxy casts, and red blood cell casts.

In some instances, a sixty-first aspect of the disclosure can be described as an educational model according to any one of the fiftieth through sixtieth aspects, wherein the resin body is made of an optically translucent resin.

In some instances, a sixty-second aspect of the disclosure can be described as an educational model according to the sixty-first aspect, wherein the optically translucent resin is resistant to yellowing over time.

In some instances, a sixty-third aspect of the disclosure can be described as an educational model according to the sixty-first aspect, wherein the optically translucent resin is an epoxy, an acrylic, a polycarbonate, a polypropylene, a methylmethacrylate acrylonitrile butadiene styrene (MABS), a polyamide, a copolyester, a thermoplastic urethane (TPU), or a polysulfone.

In accordance with various aspects of the disclosure, a sixty-fourth aspect of the disclosure can be described as an educational kit comprising a plurality of individually numbered educational models according to any one of the fiftieth through sixty-third aspects and an instructor answer key or guide, the instructor answer key or guide providing an instructor with an identification of each 3D printed structure contained in each of the plurality of individually numbered educational models.

### BRIEF DESCRIPTION OF THE DRAWINGS

In order that the present disclosure may be readily understood, aspects of the invention are illustrated by way of examples in the accompanying drawings, in which like parts are referred to with like reference numerals throughout.

FIG. 1 is an optical (light) microscope image of a naturally occurring spindle-shaped calcium oxalate monohydrate crystal found in a patient urine sample.

FIG. 2 is an optical (light) microscope image showing naturally occurring calcium oxalate dihydrate crystals, as indicated by arrows pointing thereto, found in a patient urine sample.

FIG. 3 is an optical (light) microscope image showing naturally occurring struvite crystals found in a patient urine sample.

FIG. 4 is a schematic illustration of a .STL file used for the fabrication of 3D printed crystals resembling a calcium oxalate monohydrate crystal structure.

FIG. 5 is a schematic illustration of a .STL file used for the fabrication of 3D printed crystals resembling a calcium oxalate dihydrate crystal structure.

FIG. 6 is a schematic illustration of a .STL file used for the fabrication of 3D printed crystals resembling a struvite crystal structure.

FIG. 7 is an image of fabricated crystals resembling a calcium oxalate monohydrate crystal structure (top), a calcium oxalate dihydrate crystal structure (bottom left) and a struvite crystal structure (bottom right), which were 3D printed on a glass slide.

FIG. 8 is an image (10× objective of a dissecting microscope) of 3D printed crystals resembling a calcium oxalate monohydrate crystal structure.

FIG. 9 is an image (10× objective of a dissecting microscope) of 3D printed crystals resembling a calcium oxalate dihydrate crystal structure.

FIG. 10 is an image (10× objective of a dissecting microscope) of 3D printed crystals resembling a struvite crystal structure.

FIG. 11 is another image (10× objective of a dissecting microscope) of 3D printed crystals resembling a struvite crystal structure. The focus has been adjusted using the course and fine adjustment knobs of the light microscope to better visualize the crystal's geometric shape.

FIG. 12 is a scanning electron microscope (SEM) image of 3D nanoprinted crystals resembling a struvite crystal structure (top), a calcium oxalate dihydrate crystal structure (middle), and a calcium oxalate dihydrate crystal structure cut in half (bottom). A decision was made by the design team to experiment with bisecting the calcium oxalate dihydrate crystal along the transverse plane to enhance the visual features of its geometric shape when viewed via light microscopy. Indeed, this approach translated the geometry of the calcium oxalate dihydrate crystal into a visual that was the most realistic of all the builds.

FIG. 13 is another SEM image of 3D nanoprinted crystals resembling a struvite crystal structure (top) and a calcium oxalate dihydrate crystal structure (middle and bottom). During the printing process, one surface of the crystal must be connected to the substrate that is printed on. This figure shows an alternate approach to printing the calcium oxalate dihydrate crystal structure in which the crystals have been printed at a tilt to maintain contact with the substrate. The goal of this approach was to see if printing at a tilt would enhance the visual features of the crystal's geometric shape when viewed via light microscopy.

### DETAILED DESCRIPTION

Accredited colleges of veterinary medicine are required by the American Veterinary Medical Association (AVMA) Council on Education (COE) to provide learners with hands-on diagnostic method training, including urinalysis (UA). Although teaching hospitals and affiliated clinical partners offer opportunities to test and interpret urine, caseload is unpredictable. Textbook images and published case reports offer substitutes for experiential learning. However, these read-only modalities lack experiences for learners to evaluate slides microscopically for crystalluria.

The ability to simulate abnormal findings on the diagnostic test of UA would provide consistency and reproducibility by allowing instructors to recreate common clinical presentations that students can then investigate using appropriate diagnostic methodologies. Simulation in this respect would provide guided experiences that replicate real-world diagnostic test results with the potential of building pattern recognition, competence, and confidence with interpretative techniques.

3D printed crystal models as described herein can be integrated into pre-clinical medical and veterinary school curricula in alignment with core coursework that teaches foundational knowledge in urinary tract anatomy, physiology, and pathology. Human urine adapted for commercial use would still be required by learners to practice manual detection of microscopic hematuria, pyuria, and bacteriuria. Likewise, commercially available simulated urine would still be required to replicate abnormalities in urine pH, specific gravity, glucose, protein, and ketones. 3D printed crystal models as described herein would therefore not replace current products or methodology. Instead, such models would provide an additional teaching tool for hands-on UA training to practice crystalluria detection. Thus, the printed models would provide students with a physical representation of commonly identified features on urine sediment analysis (crystals) that were previously only presented in classic textbook images. Transitioning from passive (textbook) to hands-on, experiential learning will increase student confidence and diagnostic accuracy with respect to identification of key features of urine sediment, such as struvites, calcium oxalate monohydrates, and calcium oxalate dihydrates via light microscopy or other visualization techniques.

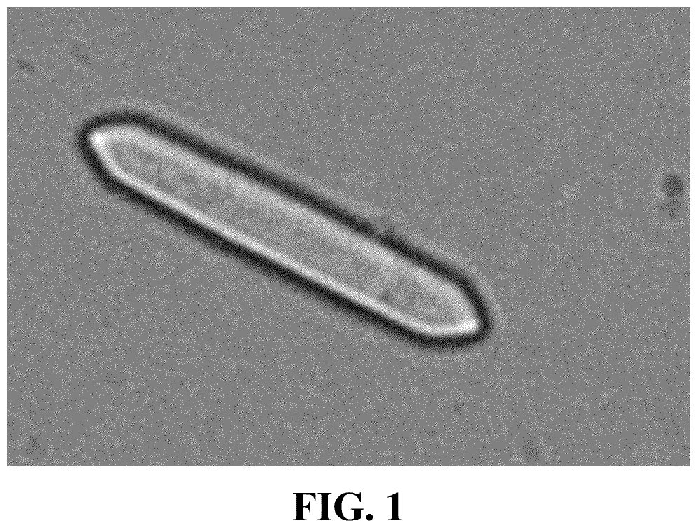

Calcium oxalate monohydrate (whewellite) is classically colorless with a variety of shapes including spindle (or a “picket fence” shape), oval (or a “hemp seed shape”) and dumbbell shapes. An optical (light) microscope image of a naturally occurring spindle-shaped calcium oxalate monohydrate crystal is shown in FIG. 1, as seen in a patient urine sample.

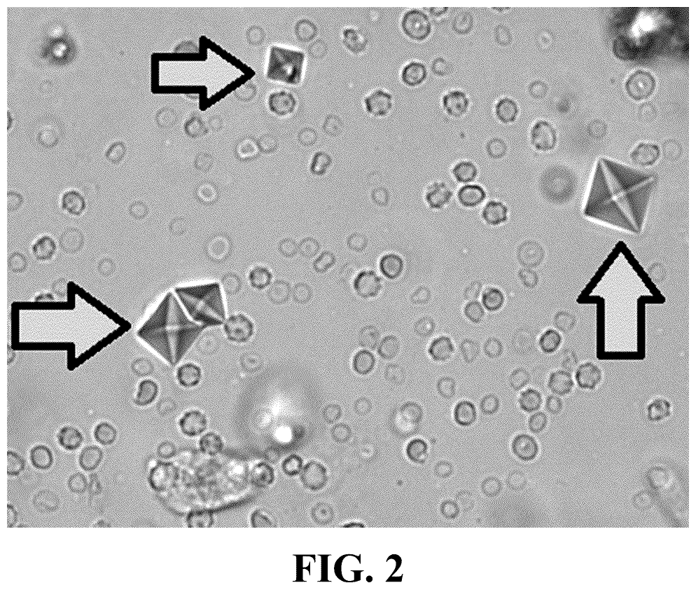

Calcium oxalate dihydrate (weddellite) is classically colorless with an octahedral (or an “envelope”) shape. The envelope appearance is due to intersecting diagonal lines that connect the corners of the square and form the basis of the crystalline structure. FIG. 2 is an optical (light) microscope image showing naturally occurring calcium oxalate dihydrate crystals, as indicated by arrows pointing thereto, found in a patient urine sample.

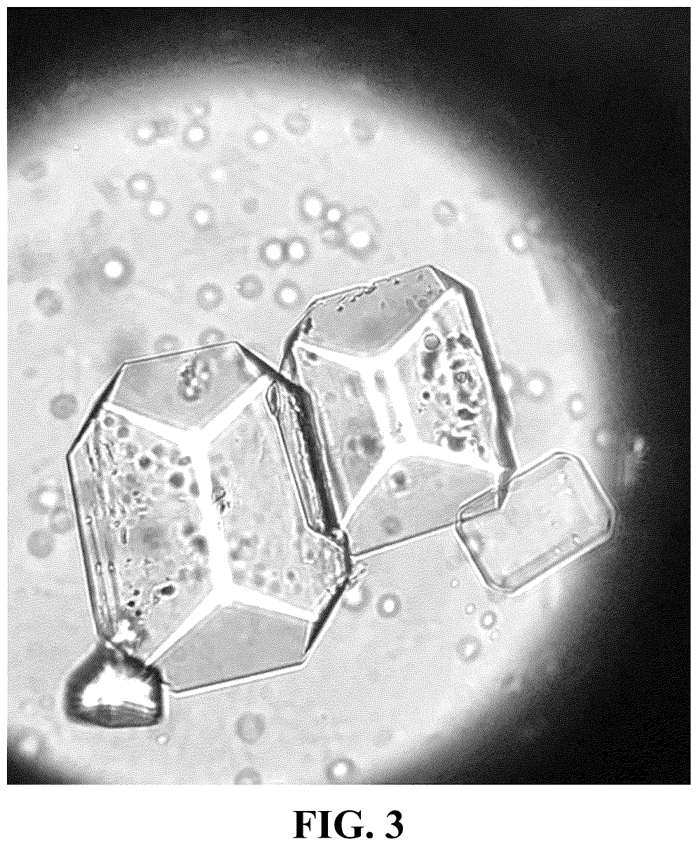

Struvite (Magnesium Ammonium Phosphate; Triple Phosphate) is classically colorless with a variety of sizes and shapes that are best described as “coffinlike prisms”. These crystalline structures vary in numbers of sides, typically ranging from three to six or more. FIG. 3 is an optical (light) microscope image showing naturally occurring struvite crystals found in a patient urine sample.

While various aspects of the present disclosure are directed to the fabrication of 3D printed structures resembling common features found in the sediment of centrifuged urine samples (such as struvite, calcium oxalate monohydrate, and calcium oxalate dihydrate crystals), the present invention should not be viewed as limited to such. In accordance with various aspects of the disclosure, three-dimensional (3-D) printed structures that resemble any structures observable in the biofluid of any animal (for example, mammals, avian species, reptiles, fish and so on), such as urine, blood, plasma, seminal fluid, pleural fluid, peritoneal fluid, cerebrospinal fluid (CSF), interstitial fluid, amniotic fluid, extracellular fluid, pericardial fluid and lymphatic fluid may be fabricated by 3D printing.

In some instances, 3D printed structures may be fabricated that resemble crystalline materials observable in a bodily fluid. Example of crystalline materials observable in a bodily fluid include, but are not limited to struvites, calcium oxalate monohydrates, calcium oxalate dihydrates, bilirubin crystals, calcium carbonate, ammonium biurate, cystine crystals, drug-associated crystals (as from administration of, for example, trimethoprim-sulfadiazine), “amorphous” crystals [for example, sodium (Na), potassium (K), magnesium (Mg) or calcium (Ca) urates, xanthine crystals, phosphates, and so on], melamine crystals, allantoin crystals, leucine crystals, tyrosine crystals, uric acid crystals, and so on.

In some instances, 3D printed structures may be fabricated that resemble normal and abnormal cells observable in a biofluid. For example, normal and abnormal spermatozoa (for example, spermatozoa with double tails, bent, coiled or stump tails, multiple or misshapen heads) can be 3D printed for use as learning tools for visualization and identification of normal and abnormal spermatozoa in an artificial seminal fluid. Also for example, normal and abnormal red blood cells (for example, nucleated red blood cells; misshapen cells indicative of sickle cell, Burr cell, and fragmented cells; polychromasia; inclusions such a Pappenheimer bodies, Cabot's ring, basophilic stippling, and Howell-Jolly) can be 3D printed for use as learning tools for visualization and identification of normal and abnormal erythrocytes in simulated blood. Also for example, normal and abnormal white blood cells [including neutrophils (mature and immature), monocytes, lymphocytes, cosinophils, and basophils] can be 3D printed for use as learning tools for visualization and identification of normal and abnormal leukocytes in simulated blood. Also, for example, normal and abnormal epithelial cells (including, but not limited to, transitional epithelial cells, squamous epithelial cells, and renal tubular epithelial cells) can be 3D printed for use as learning tools for visualization and identification of normal and abnormal cells in simulated biofluid or, by extension, simulated skin or mucous membranes. Also, for example, other elements of urine sediment such as casts (including, but not limited to, hyaline casts, cellular casts, granular casts, “fatty” casts, waxy casts, and red blood cell or hemoglobin casts) can be 3D printed for use as learning tools for visualization and identification of normal and abnormal cells in simulated urine. These examples are not limiting as to the types of normal and abnormal cells for which 3D printed structures can be fabricated to resemble according to various aspects of the disclosure.

In some instances, such 3D printed structures can exhibit micron-scale dimensions (i.e., widths, lengths, and heights each greater than 1 μm and less than 1 mm) for use as an education tool for visualization and identification under a microscope.

In some instances, the micron-scale 3D printed structures can be free standing.

In some instances, the micron-scale 3D printed structures can mounted on or adhered to a transparent substrate such as a glass or polycarbonate slide. It is envisioned that substrate mounted 3D printed structures will be particularly advantageous as an educational tool for viewing and differentiating, via light microscopy, certain crystal structures or normal and abnormal cells that will be seen in real-life clinical settings, in human and non-human animal patients. This provides consistent, reproducible, and durable slides for student training as an initial introduction to crystal types and their identification in isolation from other cellular elements that might appear in urine sediment, or the differentiation and identification of normal and abnormal cells that may be present in various body fluid. In terms of UA, affixing 3D printed structures resembling calcium oxalate monohydrate, calcium oxalate dihydrate, and struvite crystals on a single substrate allows them to be examined side by side. This eases the identification process because students do not have to change slides to examine different crystal types. They merely adjust the slide on the stage and adjust focus as needed.

In some instances, the micron-scale 3D printed structures can be dispersed or suspended in a suitable fluid, such as a simulated body fluid or water, a transparent or translucent gel, or a transparent or translucent resin body. This configuration would provide another educational tool that would, compared to glass slide-mounted samples, provide training directed to the in-situ detection and identification, and even isolation, of crystal structures and/or normal and abnormal cells.

In instances where the micron-scale 3D printed structures are suspended in a transparent or translucent resin body, suitable resins include, but are not limited to epoxies, acrylics, polycarbonates, polypropylenes, methylmethacrylate acrylonitrile butadiene styrenes (MABSs), polyamides, copolyesters, thermoplastic urethanes (TPUs), and polysulfones. In some instances, the resin body can further include a dye that provides the resin body with a color that provides a “staining” effect to the 3D printed structures. providing the 3D printed structures with an enhanced natural look when viewed using, for example, an optical microscope.

In some instances, such 3D printed structures can exhibit dimensions viewable by the naked eye such as centimeter-scale dimensions (i.e., widths, lengths and heights each greater than for example 1 cm). 3D printed structures having such dimensions can be used as an educational tool for visualization and identification with the naked eye and for direct physical handling by the teacher and student. In some instances, the centimeter-scale 3D printed structures can be free standing. In some instances, the centimeter-scale 3D printed structures can mounted on or adhered to a substrate such as a glass or polycarbonate slide.

In accordance with various aspect of the disclosure, micro-precision 3-D printed models were designed using computer-aided design (CAD) software. Geometric representations in the Standard for the Exchange of Product Data (STEP) file format were exported for 3-D printing. Prints were manufactured from high temperature laminating (HTL) resin (Boston Micro Fabrication, Maynard, MD, USA) and affixed to glass slides. Generally, any 3D printable resin or plastic may be used. Preferably, 3D printable resins or plastics used in accordance with various aspects of the disclosure will, when 3D printed in a structure resembling a crystal or normal/abnormal cell, exhibit the same or similar color, opacity and light refringent properties as exhibited by the corresponding natural crystal or normal/abnormal cell. Suitable 3D printers for the fabrication of micron-scale or submicron-scale 3D printed structures include, for example microArch™ 3D printers, series S130 or S230 (Boston Micro Fabrication, Maynard, MD, USA) or NanoOne 3D printers (UpNano GmBh, Vienna, Austria).

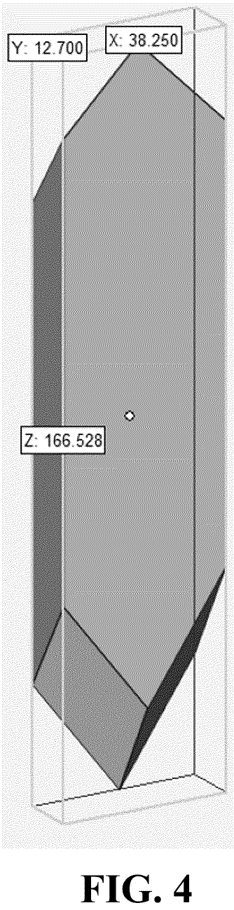

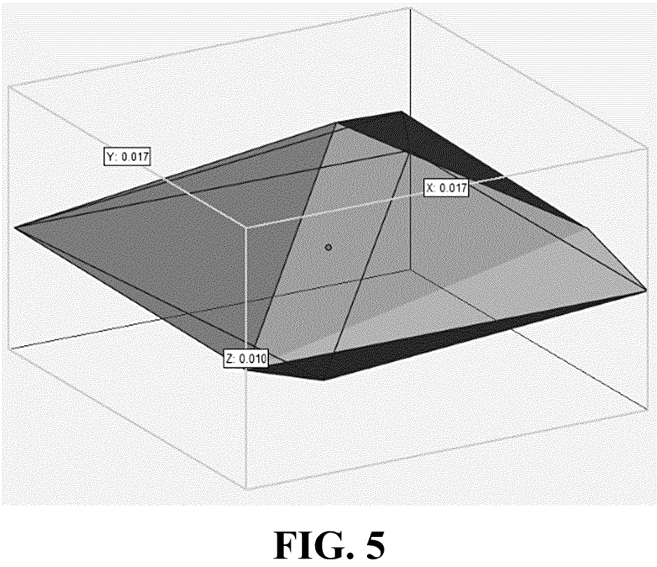

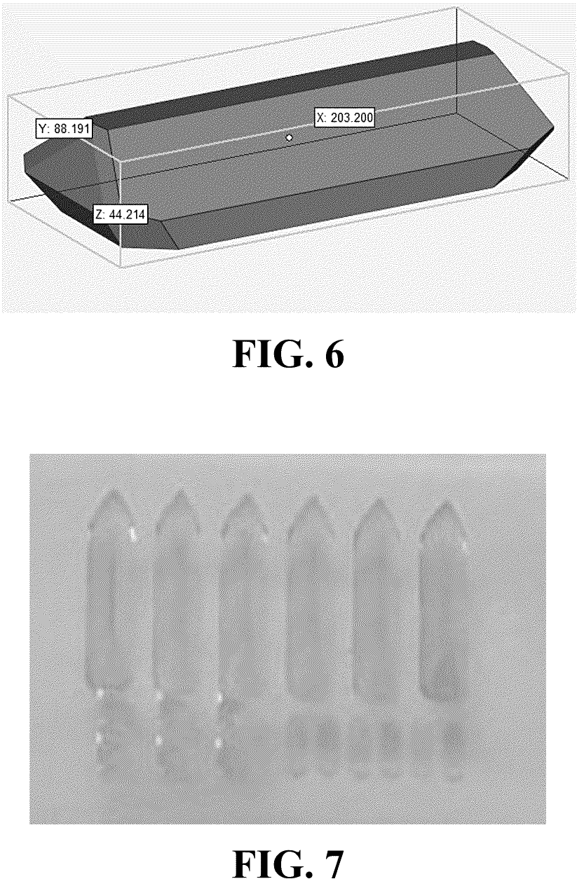

In accordance with various aspects of the disclosure, 3D crystals can be formed using a 3D printer and associated software. In this work, geometric representations of calcium oxalate monohydrate, calcium oxalate dihydrate and struvite crystal types were initially created in the .STL file format. These were subsequently converted into .STEP file format, then exported for 3-D printing on both S130 and S230 2 μm resolution platforms. Prints were made using high temperature laminating (HTL) resin, a high performance engineering material with high strength, rigidity, and heat resistance. FIGS. 4-6 are schematic illustrations of .STL files used for the fabrication of calcium oxalate monohydrate, calcium oxalate dihydrate and struvite crystals, respectively.

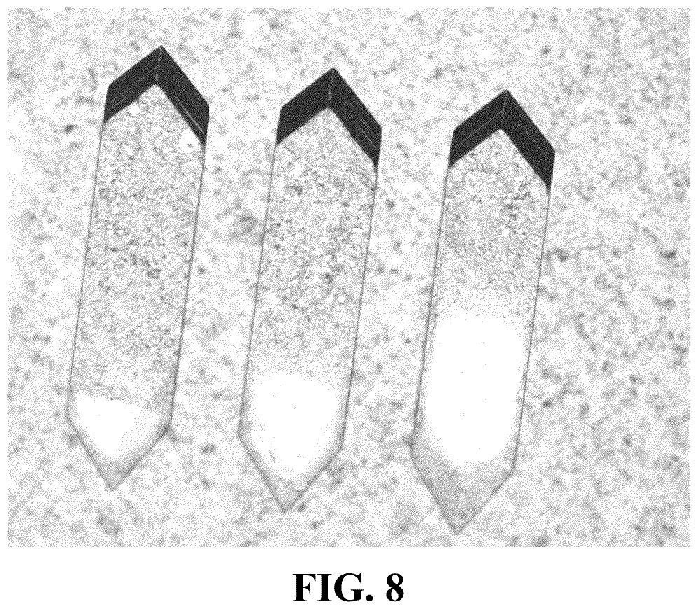

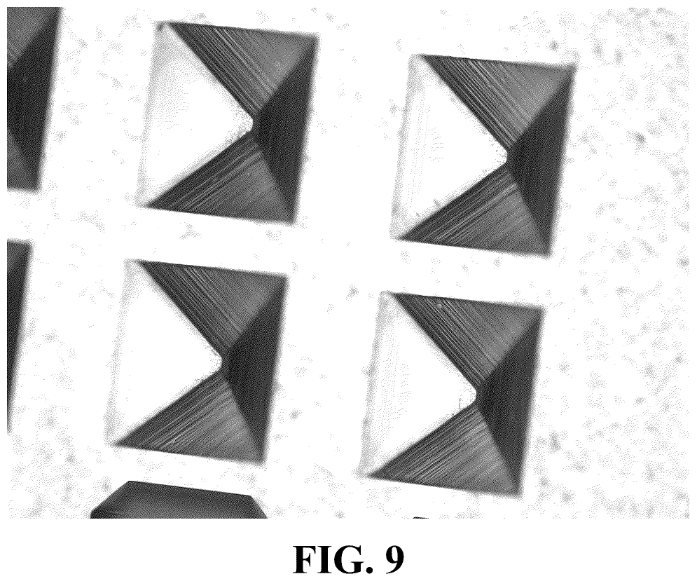

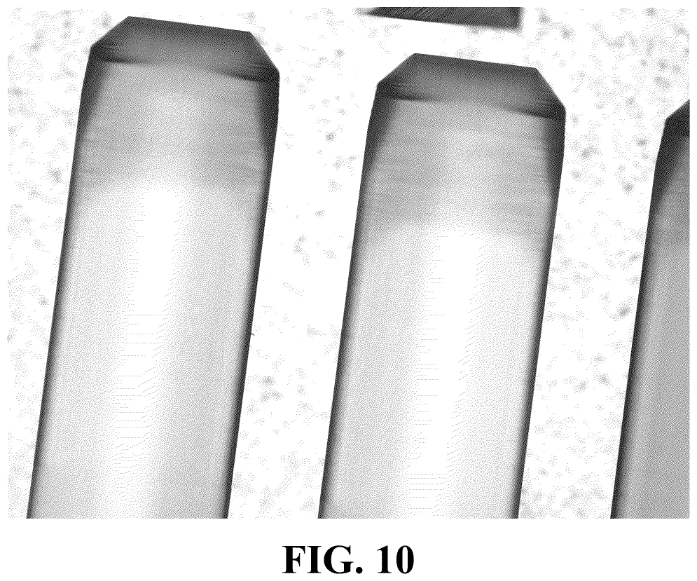

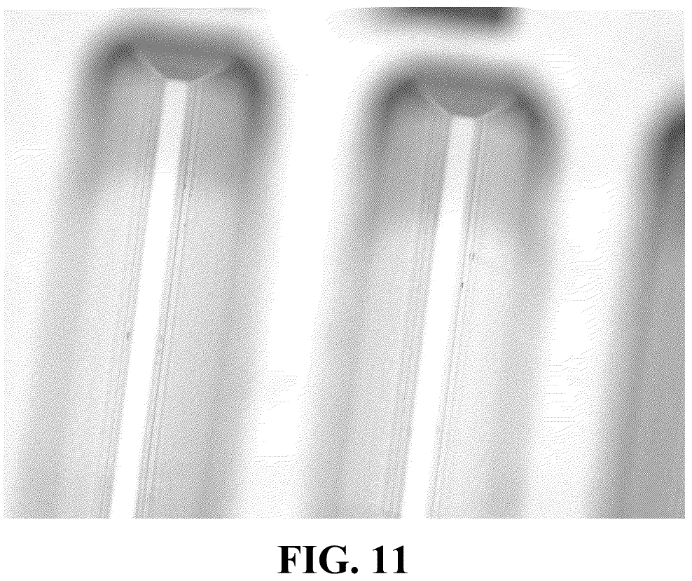

For the initial print, six of each crystal type were printed on a single glass template (FIG. 7). FIG. 8 is an image (10× objective of a dissecting microscope) of 3D printed crystals resembling a calcium oxalate monohydrate crystal structure. FIG. 9 is an image (10× objective of a dissecting microscope) of 3D printed crystals resembling a calcium oxalate dihydrate crystal structure. FIG. 10 is an image (10× objective of a dissecting microscope) of 3D printed crystals resembling a struvite crystal structure. FIG. 11 is another image (10× objective of a dissecting microscope) of 3D printed crystals resembling a struvite crystal structure. The focus has been adjusted using the course and fine adjustment knobs of the light microscope to better visualize the crystal's geometric shape.

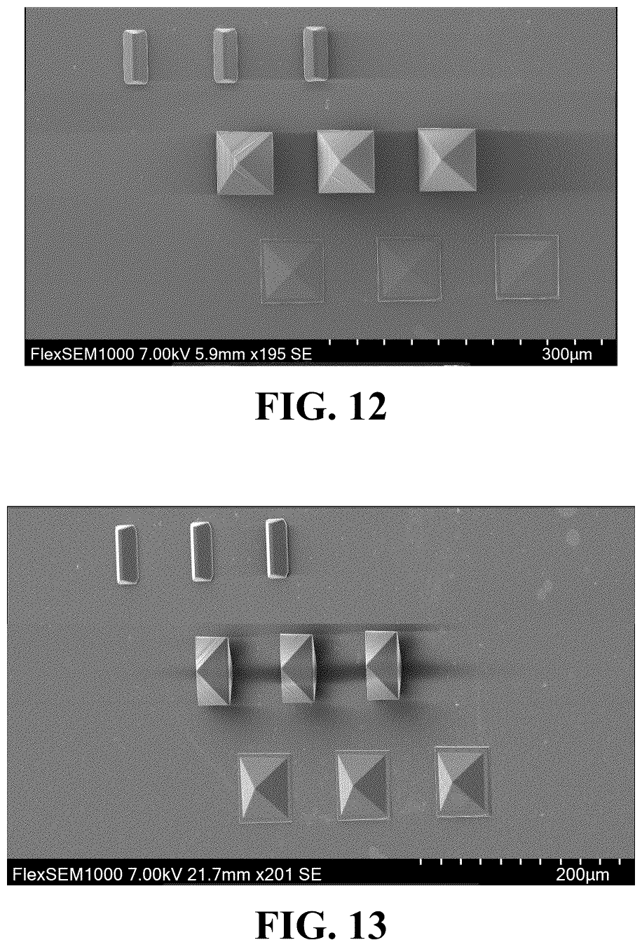

FIG. 12 is a scanning electron microscope (SEM) image of 3D printed crystals resembling a struvite crystal structure (top), a calcium oxalate dihydrate crystal structure (middle), and a calcium oxalate dihydrate crystal structure cut in half (bottom). A decision was made by the design team to experiment with bisecting the calcium oxalate dihydrate crystal along the transverse plane to enhance the visual features of its geometric shape when viewed via light microscopy. Indeed, this approach translated the geometry of the calcium oxalate dihydrate crystal into a visual that was the most realistic of all the builds. FIG. 13 is another SEM image of 3D printed crystals resembling a struvite crystal structure (top) and a calcium oxalate dihydrate crystal structure (middle and bottom). During the printing process, one surface of the crystal must be connected to the substrate that is printed on. This figure shows an alternate approach to printing the calcium oxalate dihydrate crystal structure in which the crystals have been printed at a tilt to maintain contact with the substrate. The goal of this approach was to see if printing at a tilt would enhance the visual features of the crystal's geometric shape when viewed via light microscopy.

In accordance with various aspects of the disclosure, a kit for the detection and identification of crystals commonly found in a biofluid is provided. For example, a kit may include a plurality of numbered glass slides. Each glass slide can have mounted or affixed thereon a defined number of one or more 3D printed structures resembling one or more types of crystals commonly found in said biofluid. The kit may further include an instructor key or guide that tells the instructor the number and type of 3D printed structures resembling said crystals contained on each specifically numbered glass slide.

In accordance with various aspects of the disclosure, a kit for the detection and identification of normal and abnormal cells commonly found in a biofluid is provided. For example, a kit may include a plurality of numbered glass slides. Each glass slide can have mounted or affixed thereon a defined number of one or more 3D printed structures resembling said normal cells commonly found in said biofluid. Each glass slide can further have mounted or affixed thereon a defined number of one or more 3D printed structures resembling said one or more types of abnormal cells commonly found in said biofluid. The kit may further include an instructor key or guide that tells the instructor the number and type of 3D printed structures resembling said normal and abnormal cells contained on each specifically numbered glass slide.

In accordance with various aspects of the disclosure, a kit for the detection and identification of casts commonly found in a biofluid is provided. For example, a kit may include a plurality of numbered glass slides. Each glass slide can have mounted or affixed thereon a defined number of one or more 3D printed structures resembling one or more types of casts commonly found in said biofluid. The kit may further include an instructor key or guide that tells the instructor the number and type of 3D printed structures resembling said casts contained on each specifically numbered glass slide.

In accordance with various aspects of the disclosure, a kit for the detection and identification of crystals commonly found in a biofluid is provided. For example, a kit may include a plurality of numbered tubes or containers containing a simulated bodily fluid, such as simulated urine. Each tube or container of simulated bodily fluid can have contained therein a defined number of one or more 3D printed structures resembling said one or more crystals commonly found in said biofluid. The kit may further include an instructor key or guide that tells the instructor the number and type of 3D printed structures resembling said crystals contained in each specifically numbered tube or container.

In accordance with various aspects of the disclosure, a kit for the detection and identification of normal and abnormal cells commonly found in a biofluid is provided. For example, a kit may include a plurality of numbered tubes or containers containing a simulated body fluid. Each tube or container of simulated body fluid can have contained therein a defined number of one or more 3D printed structures resembling said normal cells commonly found in said bodily fluid. Each tube or container of simulated body fluid can further have contained therein a defined number of one or more 3D printed structures resembling said one or more types of abnormal cells commonly found in said biofluid. The kit may further include an instructor key or guide that tells the instructor the number and type of 3D printed structures resembling said normal and abnormal cells contained in each specifically numbered tube or container.

In accordance with various aspects of the disclosure, a kit for the detection and identification of crystals commonly found in a biofluid is provided. For example, a kit may include a plurality of numbered containers (such as a Petri dish) containing a suitably transparent or translucent gel. Each container of gel can have suspended in said gel a defined number of one or more 3D printed structures resembling said one or more crystals commonly found in said biofluid. The kit may further include an instructor key or guide that tells the instructor the number and type of 3D printed structures resembling said crystals contained in each specifically numbered container.

In accordance with various aspects of the disclosure, a kit for the detection and identification of normal and abnormal cells commonly found in a biofluid is provided. For example, a kit may include a plurality of numbered containers (such as a Petri dish) containing a suitably transparent or translucent gel. Each container of gel can have suspended in said gel a defined number of one or more 3D printed structures resembling said normal cells commonly found in said biofluid. Each container of gel can further have suspended in said gel a defined number of one or more 3D printed structures resembling said one or more types of abnormal cells commonly found in said biofluid. The kit may further include an instructor key or guide that tells the instructor the number and type of 3D printed structures resembling said normal and abnormal cells contained in each specifically numbered container.

In accordance with various aspects of the disclosure, a kit for the detection and identification of casts commonly found in a biofluid is provided. For example, a kit may include a plurality of numbered containers (such as a Petri dish) containing a suitably transparent or translucent gel. Each container of gel can have suspended in said gel a defined number of one or more 3D printed structures resembling said one or more casts commonly found in said biofluid. The kit may further include an instructor key or guide that tells the instructor the number and type of 3D printed structures resembling said casts contained in each specifically numbered container.

In accordance with various aspects of the disclosure, a kit for the detection and identification of crystals commonly found in a biofluid is provided. For example, a kit may include a plurality of numbered resin bodies. Each resin body can have suspended therein a defined number of one or more 3D printed structures resembling said one or more crystals commonly found in said biofluid. The kit may further include an instructor key or guide that tells the instructor the number and type of 3D printed structures resembling said crystals contained in each specifically numbered resin body.

In accordance with various aspects of the disclosure, a kit for the detection and identification of normal and abnormal cells commonly found in a biofluid is provided. For example, a kit may include a plurality of numbered resin bodies. Each resin body can have suspended therein a defined number of one or more 3D printed structures resembling said one or more normal and abnormal cells commonly found in said biofluid. The kit may further include an instructor key or guide that tells the instructor the number and type of 3D printed structures resembling said normal and abnormal cells contained in each specifically numbered resin body.

In accordance with various aspects of the disclosure, a kit for the detection and identification of casts commonly found in a biofluid is provided. For example, a kit may include a plurality of numbered resin bodies. Each resin body can have suspended therein a defined number of one or more 3D printed structures resembling said one or more casts commonly found in said biofluid. The kit may further include an instructor key or guide that tells the instructor the number and type of 3D printed structures resembling said casts contained in each specifically numbered resin body.

While certain implementations have been described in terms of what may be considered to be specific aspects, the present disclosure is not limited to the disclosed aspects. Additional modifications and improvements to the aforementioned 3D printed structures may be apparent to those skilled in the art. Moreover, the many features and advantages of the disclosure are apparent from the detailed specification, and thus, it is intended by the appended claims to cover all such features and advantages of the present disclosure which fall within the spirit and scope of the disclosure.

What is claimed is:

1. An educational model, comprising
a substrate; and
one or more 3D printed structures mounted or affixed on the substrate, the one or more 3D printed structures resembling crystals, normal and/or abnormal cells, or casts found in a biofluid.

2. The educational model of claim 1, wherein the one or more 3D printed structures resemble one or more of struvite crystals, calcium oxalate monohydrate crystals and calcium oxalate dihydrate crystals.

3. The educational model of claim 1, wherein the one or more 3D printed structures resemble one or more of bilirubin crystals, calcium carbonate crystals, ammonium biurate crystals, cystine crystals, drug-associated crystals, amorphous crystals, melamine crystals, allantoin crystals, leucine crystals, tyrosine crystals, and uric acid crystals.

4. The educational model of claim 1, wherein the one or more 3D printed structures resemble normal and/or abnormal spermatozoa cells.

5. The educational model of claim 1, wherein the one or more 3D printed structures resemble normal and/or abnormal red blood cells.

6. The educational model of claim 1, wherein the one or more 3D printed structures resemble normal and/or abnormal white blood cells.

7. The educational model of claim 1, wherein the one or more 3D printed structures resemble normal and/or abnormal epithelial cells.

8. The educational model of claim 1, wherein the one or more 3D printed structures resemble hyaline casts, cellular casts, granular casts, “fatty” casts, waxy casts, and/or red blood cell casts.

9. The educational of claim 1, wherein the substrate is a microscope slide.

10. A kit comprising:
a plurality of educational models according to claim 1, each of the plurality of educational models being individually identifiable; and
an answer key or guide, the answer key or guide providing an identification of each 3D printed structure contained in each of the plurality of individually identifiable educational models.

11. An educational model, comprising one or more 3D printed structures contained in a carrier, the one or more 3D printed structures resembling crystals, normal and/or abnormal cells, or casts found in a biofluid.

12. The educational model of claim 11, wherein the carrier is a simulated biofluid.

13. The educational model of claim 11, wherein the carrier is a gel.

14. The educational model of claim 11, wherein the carrier is a resin body.

15. The educational model of claim 11, wherein the one or more 3D printed structures are dispersed or suspended in the carrier.

16. The educational model of claim 11, wherein the one or more 3D printed structures resemble one or more of struvite crystals, calcium oxalate monohydrate crystals, calcium oxalate dihydrate crystals, bilirubin crystals, calcium carbonate crystals, ammonium biurate crystals, cystine crystals, drug-associated crystals, amorphous crystals, melamine crystals, allantoin crystals, leucine crystals, tyrosine crystals, and uric acid crystals.

17. The educational model of claim 11, wherein the one or more 3D printed structures resemble normal and/or abnormal spermatozoa cells, normal and/or abnormal red blood cells, normal and/or abnormal white blood cells, or normal and/or abnormal epithelial cells.

18. The educational model of claim 11, wherein the one or more 3D printed structures resemble hyaline casts, cellular casts, granular casts, “fatty” casts, waxy casts, and/or red blood cell casts.

19. The educational model of claim 1, wherein educational model further comprises a Petri dish or a test tube, where the carrier is contained within the Petri dish or the test tube.

20. A kit comprising:
a plurality of educational models according to claim 10, each of the plurality of educational models being individually identifiable; and
an answer key or guide, the answer key or guide providing an identification of each 3D printed structure contained in each of the plurality of individually identifiable educational models.
